(19) United States
(12) Patent Application Publication
(10) Pub. No.: US 2026/0142312 A1
(43) Pub. Date: May 21, 2026

(54) SECONDARY BATTERY

(71) Applicant: SAMSUNG SDI CO., LTD., Yongin-si (KR)

(72) Inventor: Joong Woo NAM, Yongin-si (KR)

(21) Appl. No.: 19/341,079

(22) Filed: Sep. 26, 2025

(30) Foreign Application Priority Data
Nov. 18, 2024 (KR) 10-2024-0163741

(51) Int. Cl. H01M 50/317; B01D 53/04; B01D 53/26; H01F 7/02; H01M 10/52; H01M 50/533; H01M 50/578; H01M 50/586; H01M 50/588; H01M 50/59

(52) U.S. Cl. CPC H01M 50/317; B01D 53/0407; B01D 53/261; H01F 7/02; H01M 10/52; H01M 50/533; H01M 50/578; H01M 50/586; H01M 50/588; H01M 50/59; B01D 2257/104; B01D 2257/504; B01D 2257/7022; B01D 2257/80; H01M 2200/20; H01M 2220/20

(57) ABSTRACT

The present disclosure relates to a secondary battery comprising: a cylindrical can and an electrode assembly positioned in the can. An inner terminal is electrically connected to the electrode assembly and includes a connection hole. A variable connecting portion is fixed to the cylindrical can and connected to the inner terminal with the variable connection portion including a body configured to disconnected from the inner terminal by gas pressure such that the variable connecting portion is electrically disconnected from the inner terminal, and the body being reconnectable to the inner terminal by magnetic force. A terminal cover is electrically connected to the variable connecting portion and located outside of the cylindrical can.

### CROSS-REFERENCE TO RELATED APPLICATION

This application claims priority to and the benefit of Korean Patent Application No. 10-2024-0163741 filed on Nov. 18, 2024, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

The present disclosure provides a secondary battery that is reusable because separated components are reassembled by magnetic force after internal gas pressure is discharged.

In addition, the present disclosure provides a secondary battery that is capable of quickly removing gas generated inside the secondary battery.

However, the technical problems to be achieved in the embodiment of the disclosure are not limited to the technical problems mentioned above, and other technical problems not mentioned herein will be clearly understood from the following description by those skilled in the art to which the disclosure belongs.

An exemplary secondary battery according to an embodiment of the present disclosure for solving the above technical problem, may include: a cylindrical can; an electrode assembly positioned in the cylindrical can; an inner terminal electrically connected to the electrode assembly and having a connection hole; a variable connecting portion fixed to the cylindrical can and connected to the inner terminal, the variable connection portion including a body configured to disconnected from the inner terminal by gas pressure such that the variable connecting portion is electrically disconnected from the inner terminal, and the body being reconnectable to the inner terminal by magnetic force; and a terminal cover electrically connected to the variable connecting portion and located outside of the cylindrical can.

In some examples, the variable connecting portion may include a connecting body that is in contact with the inner terminal and to make an electrical connection, and a wing member that extends from the connecting body to be provided between the terminal cover and the cylindrical can, and the wing member is configured to be separated into a plurality of members by the gas pressure and then recombined by magnetic force.

In some examples, the wing member may include a first wing that is connected to the connecting body and provides a magnetic force, and a second wing facing the first wing and connected to the first wing by the magnetic force.

In some examples, the wing member may include a first magnet provided on the first wing and a second magnet provided on the second wing and facing the first magnet.

In some examples, the first magnet may be provided at an end of the first wing facing the second wing.

In some examples, the second magnet may be provided at an end of the second wing facing the first wing.

In some examples, the first magnet and the second magnet may be configured to be separated by the gas pressure and then reconnected by magnetic forces of the first magnet and the second magnet.

In some examples, the first wing and the second wing may each include an elastic material, and the first wing and the second wing are configured such that, after the wing member is separated, the first wing and the second wing are reconnected by the magnetic force and elastic restoring force.

In some examples, the inner terminal may include a movable body that is fixed to the connecting body and is configured to move together with the connecting body, and a fixed body that is connected to the movable body is positioned on the lower side of the wing member and has a connecting hole.

In some examples, the movable body and the fixed body may be reconnected by magnetic force.

An exemplary secondary battery according to an embodiment of the present disclosure may include: a cylindrical can; an electrode assembly positioned in the cylindrical can; an inner terminal electrically connected to the electrode assembly and having a connection hole; a variable connecting portion fixed to the cylindrical can and connected to the inner terminal, the variable connecting portion including a body configured to disconnected from the inner terminal by gas pressure such that the variable connecting portion is electrically disconnected from the inner terminal, and the body being reconnectable to the inner terminal by magnetic force; a terminal cover electrically connected to the variable connecting portion and located outside of the cylindrical can; and a gas absorbent positioned between the terminal cover and the variable connecting portion, the gas absorbent being configured to absorb gas.

In some examples, the secondary battery may further include an insulation gasket located between the terminal cover and the cylindrical can and blocking electrical connection between the terminal cover and the cylindrical can.

In some examples, the secondary battery may further include an insulation member located between the inner terminal and the variable connecting portion and blocking electrical connection between the inner terminal and the variable connecting portion.

In some examples, the variable connecting portion may include a connection terminal protruding toward the inner terminal and a wing member that extends from the connecting body to be provided between the terminal cover and the cylindrical can, the wing member being configured to be separated into a plurality of members by gas pressure and configured such that the member are reconnected by magnetic force.

In some examples, the connection terminal and the inner terminal may be fixed by ultrasonic welding, and an electrical connection may be blocked when the connection terminal moves away from the inner terminal by internal gas pressure.

In some examples, at least one of the connection terminal and the inner terminal may include a magnet, and the connection terminal and the inner terminal may be reconnected by magnetic force from the magnet.

In some examples, the wing member may include a first wing that is connected to the connection terminal and provides a magnetic force, and a second wing facing the first wing and connected to the first wing by magnetic force.

In some examples, the wing member may include a first magnet provided on the first wing and a second magnet provided on the second magnet and facing the first magnet.

In some examples, the first magnet may be provided at the end of the first wing facing the second wing, and the second magnet may be provided at the end of the second wing facing the first wing.

In some examples, the first magnet and the second magnet may provide electrical conductivity.

In some examples, the gas absorbent may be a composition that absorbs carbon dioxide, oxygen, ethylene, and water.

According to the present disclosure, since components separated by internal gas pressure of the secondary battery are recombined by magnetic force, the secondary battery can be reused, thereby reducing maintenance costs.

In addition, according to the present disclosure, since the gas generated inside the battery can be quickly removed by a gas absorbent, the performance and safety of the secondary battery can be improved.

However, the effects achievable through the present invention are not limited to those described above, and other technical effects not mentioned can be clearly understood by those skilled in the art from the description of the invention provided above.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing an external appearance of a secondary battery according to an embodiment of the present disclosure.

FIG. 2 is a cross-sectional view of the secondary battery according to an embodiment of the present disclosure.

FIG. 3 is a cross-sectional view showing a state in which a variable connecting portion according to an embodiment of the present disclosure is in contact with an inner terminal.

FIG. 4 is an enlarged cross-sectional view showing the inner terminal according to an embodiment of the present disclosure.

FIG. 5 is an enlarged cross-sectional view showing a wing member according to an embodiment of the present disclosure.

FIG. 6 is a cross-sectional view showing a state in which the variable connecting portion according to an embodiment of the present disclosure has moved upward by internal gas pressure.

FIG. 7 is a cross-sectional view showing a state in which the variable connecting portion according to an embodiment of the present disclosure is separated by internal gas pressure.

FIG. 8 is a cross-sectional view showing a state in which a first magnet and a second magnet are installed in parallel according to another embodiment of the present disclosure.

FIG. 9 is a cross-sectional view showing a state in which a first magnet and a second magnet are installed at an angle according to another embodiment of the present disclosure.

FIG. 10 shows an end of a first wing according to another embodiment of the present disclosure.

FIG. 11 shows an end of a first wing according to another embodiment of the present disclosure.

FIG. 12 shows an end of a first wing according to another embodiment of the present disclosure.

FIG. 13 is a cross-sectional view showing a state in which a gas absorbent is installed on the inside of a terminal cover according to an embodiment of the present disclosure.

FIG. 14 is a cross-sectional view showing a state in which a variable connecting portion is in contact with an inner terminal according to another embodiment of the present disclosure.

FIG. 15 is an enlarged cross-sectional view showing a wing member according to another embodiment of the present disclosure.

FIG. 16 is a cross-sectional view showing a state in which the variable connecting portion according to another embodiment of the present disclosure has moved upward by internal gas pressure.

FIG. 17 is a cross-sectional view showing a state in which the variable connecting portion according to another embodiment of the present disclosure is separated by internal gas pressure.

FIG. 18 is a cross-sectional view showing a state in which a gas absorbent is installed on the inside of a terminal cover according to another embodiment of the present disclosure.

FIGS. 19A and 19B are perspective views showing a battery pack including an exemplary secondary battery according to the present disclosure.

FIGS. 20A and 20B are, respectively, a perspective view and a side view showing a vehicle including an exemplary battery pack according to the present disclosure.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

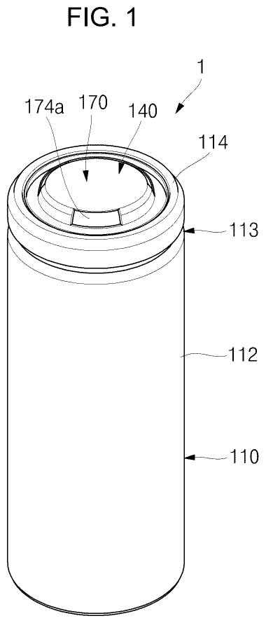

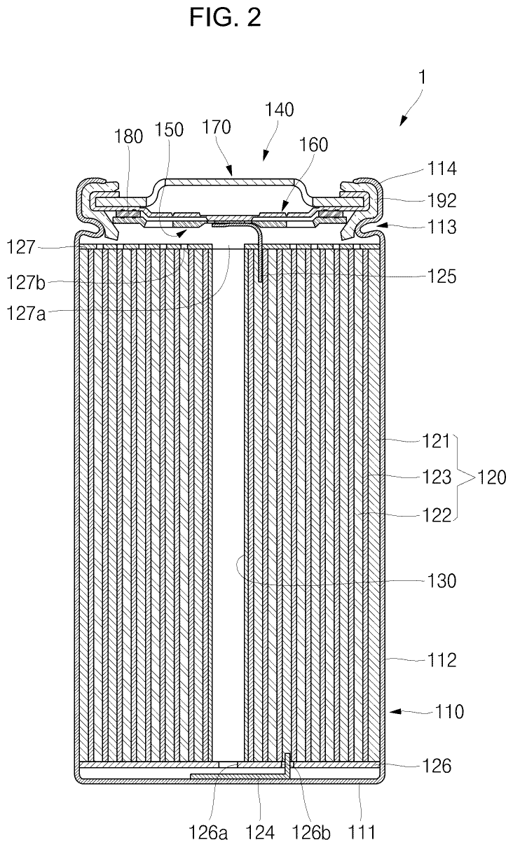

FIG. 1 is a perspective view showing an external appearance of a secondary battery 1 according to an embodiment of the present disclosure, and FIG. 2 is a cross-sectional view of the secondary battery 1. As shown in FIGS. 1 and 2, the secondary battery according to one embodiment of the present disclosure may include a cylindrical can 110, an electrode assembly 120, a negative electrode tab 124, a positive electrode tab 125, and a cap assembly 140. In addition, the secondary battery 1 may further include at least one of the negative electrode tab 124, the positive electrode tab 125, a first insulating plate 126, a second insulating plate 127, a center pin 130, and an insulation gasket 192. The cap assembly 140 may include an inner terminal 150, a variable connecting portion 160, a terminal cover 170, and an insulation member 180.

The cylindrical can 110 may be provided in various shapes such that the electrode assembly 120 is positioned inside the can 110. The cap assembly 140 may be provided on the open upper side of the cylindrical can 110.

The cylindrical can 110 includes a circular bottom portion 111 and a side portion 112 extending upward from the bottom portion 111 by a predetermined length. The upper portion of the cylindrical can 110 is open during a manufacturing process of the secondary battery 1. During an assembling process of the secondary battery 1, the electrode assembly 120 may be inserted into the cylindrical can 110 together with an electrolyte. The cylindrical can 110 may be formed of steel, a steel alloy, stainless steel, aluminum, an aluminum alloy, or an equivalent thereof, but the material is not limited to these examples in the present disclosure. In addition, to prevent the cap assembly 140 from being separated from the can 110, a beading part 113 that is recessed inwardly may be formed at the lower side of the cap assembly 140 and a crimping part 114 that is bent inwardly may be formed at the upper side of the cap assembly 140.

The electrode assembly 120 is accommodated inside the cylindrical can 110. The electrode assembly 120 includes a negative electrode plate 121 coated with a negative active material (e.g., graphite, carbon, etc.), a positive electrode plate 122 coated with a positive active material (e.g., transition metal oxide (LiCoO2, LiNiO2, LiMn2O4, etc.)), and a separator 123 positioned between the negative electrode plate 121 and the positive electrode plate 122 to prevent short circuiting and allow only the movement of lithium ions. The negative electrode plate 121, the positive electrode plate 122, and the separator 123 are wound into an approximately cylindrical shape. Here, the negative electrode plate 121 may be made of copper (Cu) or nickel (Ni) foil, and the positive electrode plate 122 may be made of aluminum (Al) foil. The separator 123 may be made of polyethylene (PE) or polypropylene (PP), but the present disclosure is not limit to these materials. A negative electrode tab 124 is connected to the negative electrode plate 121. The negative electrode tab 124 extends downwardly from the negative electrode plate 121 and is connected to the bottom portion 111 of the cylindrical can 110. Thus, the negative electrode plate 121 and the bottom portion 111 have the same polarity.

A positive electrode tab 125 is connected to the positive electrode plate 122. The positive electrode tab 125 extends upward from the positive electrode plate 122 and is connected to the inner terminal 150 provided in the cap assembly 140. Thus, the positive electrode plate 122 and the inner terminal 150 have the same polarity. The negative electrode tab 124 and the positive electrode tab 125 may be formed as separate metal plates and welded to the negative electrode plate 121 and the positive electrode plate 122, respectively. Of course, conversely, the negative electrode tab 124 may protrude and extend to the upper portion of the electrode assembly 120, and the positive electrode tab 125 may protrude and extend to the lower portion of the electrode assembly 120. In addition, the negative electrode tab 124 may be made of copper or nickel, and the positive electrode tab 125 may be made of aluminum. But the present disclosure is not limit these materials.

The negative electrode tab 124 of the electrode assembly 120 may be welded to the bottom portion 111 of the cylindrical can 110. The cylindrical can 110 may thereby operate as a negative electrode. Of course, conversely, the positive electrode tab 125 may be welded to the bottom portion 111 of the cylindrical can 110, in which case the cylindrical can 110 may operate as a positive electrode.

The first insulation plate 126 is coupled to the cylindrical can 110, and has a first hole 126a formed at the center and a second hole 126b formed outward of the first hole 126a. The first insulation plate 126 may be interposed between the electrode assembly 120 and the bottom portion 111. The first insulation plate 126 prevents the electrode assembly 120 from electrically contacting the bottom portion 111 of the cylindrical can 110. In particular, the first insulation plate 126 prevents the positive electrode plate 122 of the electrode assembly 120 from electrically contacting the bottom portion 111. When a large amount of gas is generated due to an abnormality in the secondary battery 1, the gas can quickly move upward through the center pin 130 installed to the first hole 126a. The negative electrode tab 124 may penetrate the second hole 126b and be welded to the bottom portion 111.

The second insulation plate 127 is coupled to the cylindrical can 110 and has a first hole 127a formed at the center and a plurality of second holes 127b formed outwardly from the first hole 127a. The second insulation plate 127 may be interposed between the electrode assembly 120 and the cap assembly 140. The second insulation plate 127 prevents the electrode assembly 120 from electrically contacting the cap assembly 140. In particular, the second insulation plate 127 prevents the negative electrode plate 121 of the electrode assembly 120 from electrically contacting the cap assembly 140. When a large amount of gas is generated due to an abnormality in the secondary battery 1, the gas can quickly move to the cap assembly 140 through the first hole 127a. The positive electrode tab 125 may extend through one of the second holes 127b and be welded to the cap assembly 140. In addition, the remaining second holes 127b, which do not receive the positive electrode tab 125, may function as passages to allow the electrolyte to quickly flow into the electrode assembly 120 during an electrolyte injection process.

Diameters of the holes 126a and 127a of the first and second insulation plates 126 and 127 are smaller than the diameter of the center pin 130, thereby preventing the center pin 130 from electrically contacting the bottom portion 111 of the cylindrical can 110 or the cap assembly 140, for example, in the event of an external impact to the secondary battery 1.

The center pin 130 may be a hollow circular pipe and may be coupled to the center of the electrode assembly 120. The center pin 130 may be formed of steel, a steel alloy, stainless steel, aluminum, an aluminum alloy, or polybutylene terephthalate, but the present disclosure is not limited to these materials. The center pin 130 suppresses deformation of the electrode assembly 120 during charging and discharging of battery and serves as a passage for gas generated inside the secondary battery 1. In some cases, the center pin 130 may be omitted.

The insulation gasket 192 is positioned between the terminal cover 170 and the cylindrical can 110 and is made of an insulating material. The insulation gasket 192 may be provided in various shapes that block an electrical connection between the terminal cover 170 and the cylindrical can 110. The insulation gasket 192 insulates the cap assembly 140 from the side portion 112 of the cylindrical can 110.

The insulation gasket 192 is provided in the upper opening of the cylindrical can 110. The insulation gasket 192 is compressed between the beading part 113 and the crimping part 114 formed in the side portion 112 of the cylindrical can 110. Further, the insulation gasket 192 is compressed between the outer periphery of the variable connecting portion 160 and the cylindrical can 110. The configuration is such that the variable connecting portion 160 wraps around the edge of the terminal cover 170, and the insulation gasket 192 wraps around the edge of the variable connecting portion 160. The insulation gasket 192 provides elasticity while being compressed between the cap assembly 140 and the cylindrical can 110, thereby improving sealing efficiency.

The insulation gasket 192 may be formed of a resin material such as polyethylene (PE), polypropylene (PP), polyethylene terephthalate (PET), etc. The insulation gasket 192 can prevent the cap assembly 140 from separating from the cylindrical can 110.

An electrolyte (not shown) is injected into the cylindrical can 110, which enables lithium ions generated by an electrochemical reaction at the negative electrode plate 121 and positive electrode plate 122 inside the battery to move during charging and discharging. The electrolyte may be a non-aqueous organic electrolyte that is a mixture of a lithium salt and a high-purity organic solvent. In other cases, the electrolyte may be a polymer using a polymer electrolyte or a solid electrolyte. But the type of the electrolyte is not limited herein.

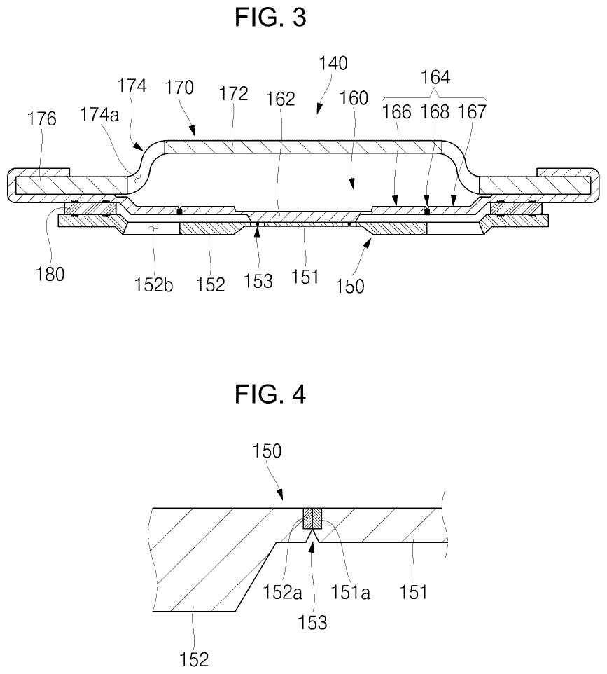

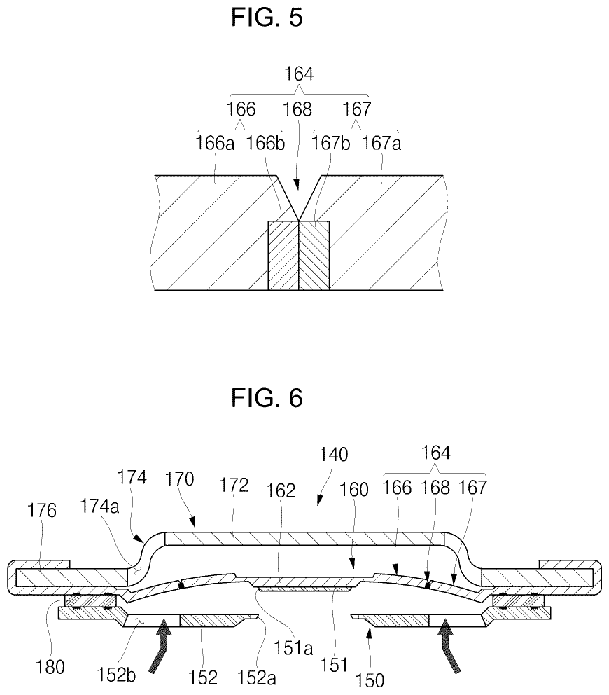

FIG. 3 is a cross-sectional view showing a state in which the variable connecting portion 160 according to an embodiment of the present disclosure is in contact with the inner terminal 150, FIG. 4 is an enlarged cross-sectional view showing the inner terminal 150 according to an embodiment of the present disclosure, and FIG. 5 is an enlarged cross-sectional view showing a wing member 164 according to an embodiment of the present disclosure. As shown in FIGS. 3 to 5, the cap assembly 140 includes the terminal cover 170 having a plurality of terminal holes 174a formed therein. The variable connecting portion 160 is positioned at the lower portion of the terminal cover 170, the insulation member 180 is positioned at the lower portion of the variable connecting portion 160, and an inner terminal 150 is positioned at the lower portion of the insulation member 180 and has a connection hole 152b.

The inner terminal 150 is electrically connected to the electrode assembly 120 and may be provided in various shapes such that the connection hole 152b allows for gas movement. The inner terminal 150 may be formed as a roughly circular plate. The inner terminal 150 according to an embodiment of the present disclosure includes a movable body 151 and a fixed body 152. And a magnet is provided in at least one of the movable body 151 and the fixed body 152 so that the movable body 151 and the fixed body 152 may be held together by a magnetic force.

The movable body 151 is fixed to the connecting body 162 of the variable connecting portion 160 and can move together with the connecting body 162 as a result of internal gas pressure generated inside the secondary battery 1. The movable body 151 may be formed in a circular plate shape.

A movable magnet 151a may be provided on the outer edge of the movable body 151. The movable magnet 151a may be formed in a ring shape on the outer edge of the movable body 151. Alternatively, the movable magnet 151a may be provided as a plurality of movable magnets. Various other forms of the movable magnet 151a are possible, including a configuration where movable magnets 151a are provided on the outer edge of the movable body 151 at set intervals.

The fixed body 152 is connected to the movable body 151 and is located on the lower side of the wing member 164. The fixed body 152 has a connection hole 152b that forms a passage through gas can move. The fixed body 152 is located on the outer periphery of the movable body 151, and the insulation gasket 192 is located between the fixed body 152 and the cylindrical can 110 to provide electrical insulation. A fixed magnet 152a is provided on the side of the fixed body 152 facing the movable magnet 151a provided on the movable body 151. The polarities of the magnets 151a and 152a provided to the movable body 151 and the fixed body 152 are opposite to each other, and, thus, the movable body 151 and the fixed body 152 can be maintained in a state fixed state relative to each other by magnetic force.

The positive electrode tab 125 is connected to the inner terminal 150 making an electrical connection between the inner terminal 150 and the electrode assembly 120. The positive electrode tab 125 may be fixed to at least one of the movable body 151 and the fixed body 152. When the positive electrode tab 125 is connected to the fixed body 152, and the fixed body 152 is connected to the movable body 151, current having moved through the positive electrode tab 125 can move by way of the fixed body 152 and the movable body 151.

The fixed magnet 152a may be provided on the inner edge of the fixed body 152. Alternatively, the fixed magnet 152a may be provided as a plurality of fixed magnets. But various other arrangements and configurations are possible, including magnets being installed on the inner edge of the fixed body 152 at set intervals.

The movable magnet 151a and the fixed magnet 152a may only provide magnetic force, or may provide both magnetic force and electrical conductivity. The movable magnet 151a and the fixed magnet 152a may include at least one of iron, nickel, cobalt, and a magnetic alloy.

Iron is naturally magnetic and exhibits magnetism when magnetized. In addition, iron is a metal and there has excellent electrical conductivity. Nickel is a ferromagnetic material, which means it has both magnetic force and electrical conductivity. Cobalt is an electrically conducting material while having magnetism. Cobalt alloys are used in many electrical and magnetic devices that utilize magnetic force and conductivity.

Magnetic alloys include AlNiCo, permalloy, and the like. AlNiCo is an alloy of aluminum (Al), nickel (Ni), and cobalt (Co), which has strong magnetic force and yet electrically conductive. Permalloy is an alloy of iron and nickel, which is a magnetic material and has high electrical conductivity.

A lower notch 153 in the form of a concave groove may be provided at the boundary where the movable body 151 and the fixed body 152 are connected. A portion where the lower notch 153 is formed is be thinner than other portions of the inner terminal 150,. Thus, when the inner terminal 150 is deformed by internal gas pressure, the deformation occurs around the portion where the lower notch 153 is formed.

A connection between the movable body 151 and the fixed body 152 is made around the lower notch 153. The movable body 151 and the fixed body 152 may be connected by magnets as described above. Alternatively, portions of the movable body 151 and the fixed body 152 may be connected, in various other ways, including the movable body 151 and the fixed body 152 being structurally connected along with the magnetic connection.

The variable connecting portion 160 is fixed to the cylindrical can 110 and in contact with the inner terminal 150, and the variable connecting portion 160 is separable from the inner terminal 150 by gas pressure inside of the cylindrical can 110 to thereby stop the flow of current. The variable connecting portion 160 may be provided in various shapes that can be ruptured by internal gas pressure and then reconnected with the inner terminal by magnetic force.

When an abnormal internal pressure occurs inside the cylindrical can 110, the variable connecting portion 160 discharges internal gas while blocking current. more specifically, when the internal gas pressure of the cylindrical can 110 becomes higher than the operating pressure of the variable connecting portion 160, the variable connecting portion 160 moves upward by the gas discharged through the connection hole 152b of the inner terminal 150. The variable connecting portion 160 having moved upward is separated from the fixed body 152 of the inner terminal 150 and is electrically isolated from the inner terminal 150.

The variable connecting portion 160 may be formed as a circular structure corresponding to the terminal cover 170. The outer periphery of the variable connecting portion 160 is provided so as to be in contact with the outer periphery of the terminal cover 170. In addition, the outer periphery of the variable connecting portion 160 extends in a shape that wraps around the edge of the terminal cover 170. Thus, the variable connecting portion 160 and the inner terminal 150 are electrically connected. That is, the edge of the variable connecting portion 160 extends upward from the terminal cover 170 while covering the edge of the terminal cover 170 so that the upper surface of the edge of the terminal cover 170 is covered. In addition, the variable connecting portion 160 can recontact the inner terminal 150 because of the magnetic force provided by the magnets 151a and 152a to restore the flow of current. Thus, the secondary battery 1 can be further used or reused. The variable connecting portion 160 according to an embodiment of the present disclosure includes the connecting body 162 and the wing member 164.

The connecting body 162 is in contact with the inner terminal 150 and may be formed in various shapes that make an electrical connection. The connecting body 162 is located on the upper side of the movable body 151 and may be formed in a circular shape. The connecting body 162 and the movable body 151 may be fixed to each other by welding, etc. The connecting body 162 is located at the center of the variable connecting portion 160. The connecting body 162 is located on the lower side of the terminal cover 170 and may be in contact with the upper side of the movable body 151. In order to strengthen the conductivity of the connecting body 162, a conductive coating, such as a copper coating, may be applied, thereby minimizing the loss of current.

The wing member 164 extends from the connecting body 162 between the terminal cover 170 and the cylindrical can 110, and may be various shapes that can be separated into multiple members by internal gas pressure and then reconnected by the magnetic force. Portions of the wing member 164 other than the magnet(s) are made of a high-elasticity polymer or a composite material that is both durable and elastic. The wing member 164 includes a first wing 166 and a second wing 167. The first wing 166 and the second wing 167 may be separated from each other by the internal gas pressure of the secondary battery 1 and then reconnected by magnetic force.

The first wing 166 is connected to the connecting body 162 and may be various shapes. The first wing 166 is provided with the first magnet 166b. The first magnet 166b may be positioned at the end of the first wing 166 facing the second wing 167. The first wing 166 is located at the outer periphery of the connecting body 162 and includes a first body 166a integrally formed with the connecting body 162 and a first magnet 166b fixed to an outer end of the first body 166a. The first body 166a is located between the connecting body 162 and the second wing 167 and may be formed in a donut shape. The inner side of the first body 166a may be connected to the connecting body 162, and the outer side of the first body 166a may be connected to the second wing 167. The first magnet 166b may be positioned on the outer edge of the first body 166a. The first magnet 166b may be formed in a ring shape on the outer edge of the first body 166a. Alternatively, the first magnet 166b may be provided in plurality and may be positioned on the outer edge of the first body 166a at a set intervals. Various other arrangements are possible, including arrangements enabling a uniform magnetic force distribution. The first magnet 166b and the second magnet 167b may also be designed to be easily separated and reconnected by combining a rigid magnetic material and an elastic material.

The second wing 167 is installed at a position facing the first wing 166, and may be provided in various shapes that can be connected to the first wing 166 by magnetic force. The second wing 167 is installed at the outer periphery of the first wing 166. A first end of the second wing 167 is connected to the first wing 166, and a second end of the second wing 167 is shaped to wrap around the edge of the terminal cover 170.

The second wing 167 is located on the outer periphery of the first wing 166 and includes a second body 167a in contact with the terminal cover 170 and a second magnet 167b fixed to a first end of the second body 167a. The second magnet 167b provided on the second wing 167 faces the first magnet 166b. The first magnet 166b and the second magnet 167b may be separated by internal gas pressure and then reconnected by the magnetic forces of the first magnet 166b and the second magnet 167b. The second body 167a is located at the outer periphery of the first body 166a and may be formed in a donut shape or a ring shape with a larger inner diameter than a diameter of the first body 166a.

The second magnet 167b may be a ring shape on the inner edge of the second body 167a. Alternatively, the second magnet 167b may be provided in plurality, and various modifications are possible, including multiple second magnets 167b being installed on the inner edge of the second body 167a at set intervals.

The first wing 166 and the second wing 167 may each include an elastic material. After the wing member 164 is separated, the first and second wings 166 and 167 may be reconnected by magnetic force and elastic restoring force. The materials of the first magnet 166b and the second magnet 167b are the same as or similar to the materials of the movable magnet 151a and the fixed magnet 152a, so a detailed description thereof is omitted.

An upper notch 128 in the form of a concave groove may be provided at the boundary where the first wing 166 and the second wing 167 are connected. A portion where the upper notch 128 is formed is thinner than other portions of the wing member 164. Thus, when the wing member 164 is deformed by internal gas pressure, the deformation occurs around the portion where the upper notch 128 is formed.

A connection between the first wing 166 and the second wing 167 is made around the upper notch 128. The first wing 166 and the second wing 167 may be connected by magnetic force, as described above. Portions of the first wing 166 and second wing 167 may be connected in various other ways, including the first wing 166 and second wing 167 being structurally connected.

The terminal cover 170 is electrically connected to the variable connecting portion 160 and may be various shapes on the outside of the cylindrical can 110. The terminal cover 170 has a convex upper portion so as to be electrically connected to an external circuit. In addition, the terminal cover 170 has a terminal hole 174a that provides a passage through which the gas generated inside the cylindrical can 110 can be discharged. The terminal cover 170 is electrically connected to the electrode assembly 120 and transmits current generated in the electrode assembly 120 to the external circuit.

The terminal cover 170 of the cap assembly 140 includes a terminal part 172, a connection part 174, and an extension part 176, which are sequentially positioned in an outward direction from the center of the terminal cover 170.

The terminal part 172 is a flat structure and may be located at the center of the terminal cover 170. In addition, when the terminal part 172 is formed into a module by connecting a plurality of secondary batteries 1 in series or in parallel, a positive electrode pack tab (PT) for connecting the plurality of secondary batteries 1 to each another may be welded to the upper surface of the terminal part 172.

The connection part 174 is bent downward from the edge of the terminal part 172 and includes at least one terminal hole 174a. When the first wing 166 and the second wing 167 of the variable connecting portion 160 are separated, the terminal hole 174a releases the internal gas of the cylindrical can 110 to outside of the battery.

The extension part 176 may extend outwardly in a horizontal direction from the lower end of the connection part 174. The edge of the extension part 176 may be wrapped around by the variable connecting portion 160.

The terminal cover 170 may be made of aluminum, an aluminum alloy, steel, a steel alloy, nickel, stainless steel, a nickel alloy and equivalents thereof. But the present disclosure is not limited to these examples.

The insulation member 180 is positioned between the inner terminal 150 and the variable connecting portion 160, and is made of an insulating material. The insulation member may be various shapes that block an electrical connection between the inner terminal 150 and the variable connecting portion 160. The insulation member 180 is interposed between the outer periphery of the variable connecting portion 160 and the outer periphery of the inner terminal 150. The insulation member 180 may be formed, for example, of a resin material such as polyethylene (PE), polypropylene (PP), polyethylene terephthalate (PET), etc.

FIG. 6 is a cross-sectional view showing a state in which the variable connecting portion 160 according to an embodiment of the present disclosure has moved upward by internal gas pressure. As shown in FIG. 6, the movable body 151 moves upward due to the internal gas pressure generated inside the secondary battery 1. Thus, the movable body 151 and the fixed body 152 are separated. As the movable body 151 and the fixed body 152 are separated, transmission of current through the movable body 151 is blocked. In a state in which the movable body 151 is fixed to the lower side of the connecting body 162, the movable body 151 and the connecting body 162 move upward.

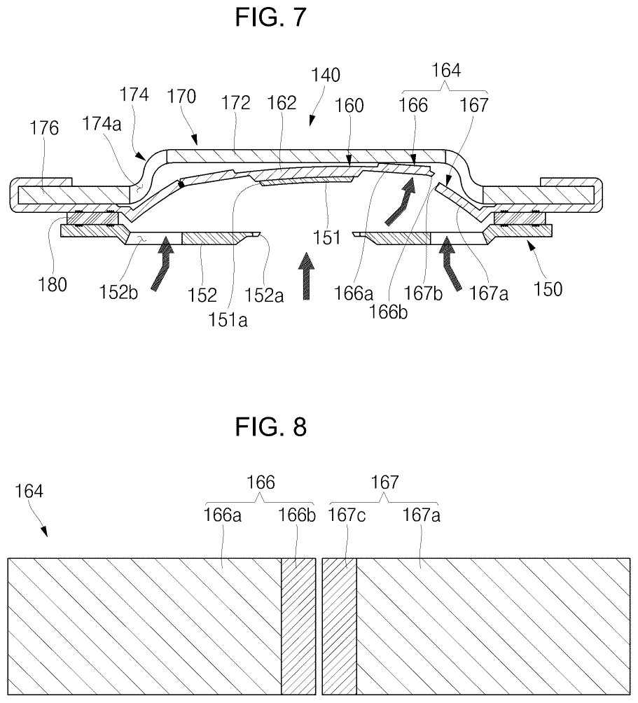

FIG. 7 is a cross-sectional view showing a state in which the variable connecting portion 160 according to an embodiment of the present disclosure is separated by internal gas pressure. As shown in FIG. 7, since the first wing 166 and the second wing 167 are separated by internal gas pressure, gas is discharged through a space between the first wing 166 and the second wing 167. The gas discharged to the outside of the wing member 164 is discharged to the outside of the terminal cover 170 through the terminal hole 174a of the terminal cover 170.

After the discharging of gas is completed, the first magnet 166b of the first wing 166 and the second magnet 167b of the second wing 167 are reconnected by magnetic force. In addition, the movable magnet 151a of the movable body 151 and the fixed magnet 152a of the fixed body 152 are reconnected by magnetic force. Therefore, as shown in FIG. 3, the current having moved to the inner terminal 150 is transmitted to the terminal cover 170 through the variable connecting portion 160.

Hereinafter, another embodiment of the first magnet 166b will now be described with reference to the drawing.

FIG. 8 is a cross-sectional view showing a state in which a first magnet 166c and a second magnet 167c are parallel to each other according to another embodiment of the present disclosure. As shown in FIG. 8, the first magnet 166c and the second magnet 167c may be provided at ends facing the first wing 166 and the second wing 167. The first wing 166 and the second wing 167 are fixed by magnetic force. But when gas is discharged, the first magnet 166c and the second magnet 167c may be separated from each other. After discharging of gas is completed, the first magnet 166c and the second magnet 167c are reconnected by magnetic force, and thus the first wing 166 and the second wing 167 are reconnected. The first magnet 166c and the second magnet 167c have electrical conductivity as well as magnetic force. Since the first magnet 166c and the second magnet 167c are installed in parallel and vertically, the contact area between the first magnet 166c and the second magnet 167c is increased, thereby increasing the bonding force between the first wing 166 and the second wing 167 due to the increased magnetic force.

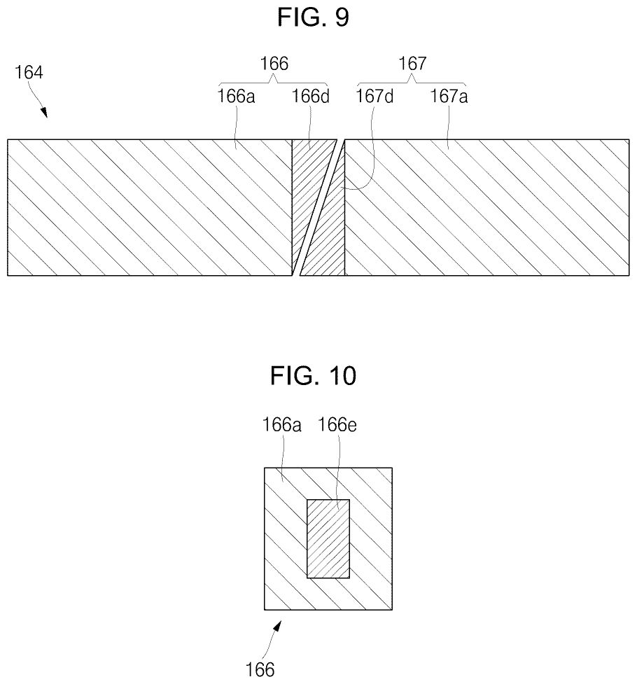

FIG. 9 is a cross-sectional view showing a state in which a first magnet 166d and a second magnet 167d are installed at an angle relative to a vertical direction according to another embodiment of the present disclosure. As shown in FIG. 9, the ends where the first wing 166 and the second wing 167 face each other are installed at an angle. In addition, the first magnet 166d and the second magnet 167d may be positioned at the ends where the first wing 166 and the second wing 167 face each other. The first magnet 166d may have a triangular cross-section shape, and the second magnet 167d may also have a triangle cross-section shape. The inclined surfaces of the first magnet 166d and the second magnet 167d face each other and may be positioned at an angle relative to the upper and lower surfaces of the winds 166 and 167. Since the first magnet 166d and the second magnet 167d form inclined surfaces and are fixed by magnetic force, separating and reconnecting the first magnet 166d and the second magnet 167d can be performed more quickly. The first magnet 166d and the second magnet 167d have electrical conductivity as well as magnetic force.

FIG. 10 shows an end of a first wing 166 according to another embodiment of the present disclosure. FIG. 10 is a side view of the first body 166a. As shown in FIG. 10, a first magnet 166e is provided at the center of the end of the first body 166a. The first body 166a is a square edge area along the perimeter of the first magnet 166e. The first magnet 166e may be positioned in the first body 166a and be various shapes. The first magnet 166e has a cube shape of a rectangular parallelepiped and may be inserted into the end of the first body 166a. The first magnet 166e is located at the center of the end of the first wing 166, and the first body 166a is located on the outer perimeter of the first magnet 166e.

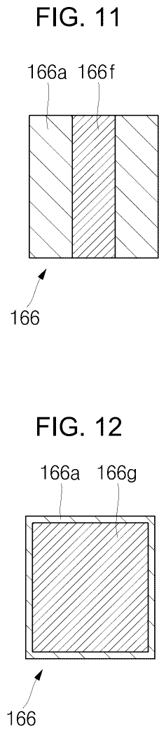

FIG. 11 shows an end of a first wing 166 according to another embodiment of the present disclosure. As shown in FIG. 11, a first magnet 166f is positioned at the center of the first body 166a. The first magnet 166f extends in the vertical direction, and the first body 166a is located on both the left and right sides of the first magnet 166f.

FIG. 12 shows an end of a first wing 166 according to another embodiment of the present disclosure. As shown in FIG. 12, a first magnet 166g is positioned on the inner side of the end of the first body 166a. The first body 166a is located in the square edge area along the outer perimeter of the first magnet 166g. Variations are possible, including only the first magnet 166g being located on the end of the first wing 166.

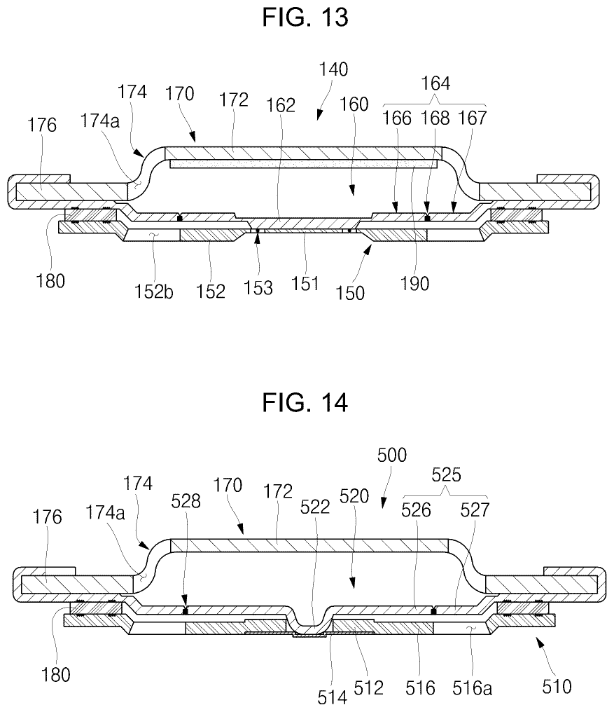

FIG. 13 is a cross-sectional view showing a gas absorbent 190 inside of a terminal cover 170 according to an embodiment of the present disclosure. As shown in FIG. 13, the gas absorbent 190 positioned between the terminal cover 170 and the variable connecting portion 160 and removes gas inside the cap assembly 140. The gas absorbent 190 may be a composition that absorbs carbon dioxide, oxygen, ethylene, and moisture. The gas absorbent 190 may include activated carbon or zeolite. The gas absorbent 190 absorbs gas through a chemical reaction when gas is generated inside the secondary battery 1, and prevents the absorbed gas from affecting the electrochemical reaction inside the battery. The gas absorbent 190 may absorb lithium salt and fluoride (F) and removes gas generated due to electrolyte decomposition. The gas absorbent 190 may effectively absorb oxygen to reduce the risk of explosion inside the secondary battery 1. The gas absorbent may be fixed to the lower surface of the terminal part 172.

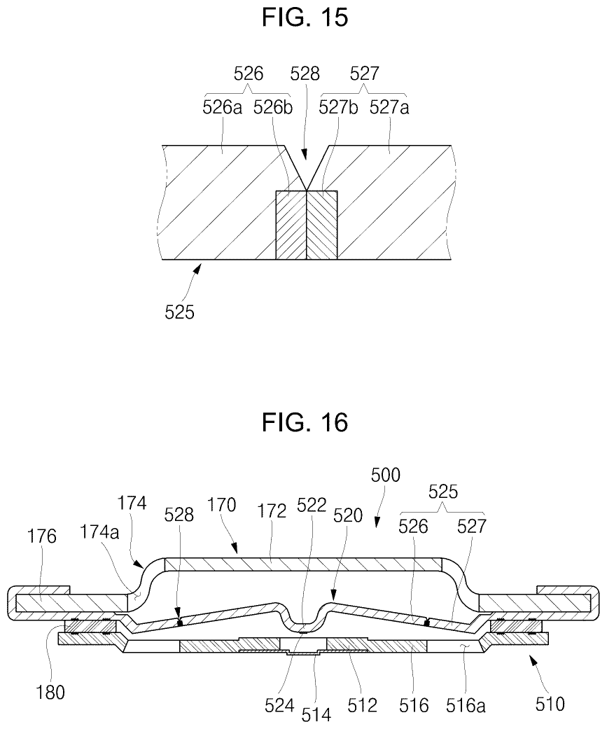

FIG. 14 is a cross-sectional view showing a state in which a variable connecting portion 520 is in contact with an inner terminal 510 according to another embodiment of the present disclosure, and FIG. 15 is an enlarged cross-sectional view showing a wing member 525 according to another embodiment of the present disclosure. As shown in FIGS. 14 and 15, a cap assembly 500 includes an inner terminal 510, a variable connecting portion 520, a terminal cover 170, and an insulation member 180. Detailed descriptions of structures and configurations identical or similar to those described above will be omitted.

The inner terminal 510 is electrically connected to the electrode assembly 120 and may be various shapes having a connection hole 516a. The inner terminal 510 according to another embodiment of the present disclosure includes a central body 512 and a fixed body 516. The inner terminal 510 may be formed as a substantially circular plate.

The central body 512 may be formed in a disc shape and located in the center of the inner terminal 510. A support plate 514 is located at the center of the central body 512. The support plate 514 is formed to have a smaller thickness than the central body 512 located on the outer side of the support plate 514. Thus, a groove is formed on the upper side of the support plate 514.

The fixed body 516 is connected to the central body 512 and is located on the lower side of the variable connecting portion 520. The fixed body 516 is provided with a connection hole 516a through which gas can pass. The fixed body 516 is located on the outer periphery of the central body 512. An insulation member 180 is located between the fixed body 516 and the variable connecting portion 520.

The variable connecting portion 520 is fixed to the cylindrical can 110 and in contact with the inner terminal 510. The variable connecting portion 520 is separable from the inner terminal 510 by gas pressure inside the cylindrical can 110 to thereby block the flow of current. The variable connecting portion 520 may be provided in various shapes of providing a body that is ruptured by internal gas pressure. The variable connecting portion 520 according to another embodiment of the present disclosure may include a connection terminal 522 and a wing member 525. The variable connecting portion 520 may further include an upper notch 528.

The connection terminal 522 may protrude toward the inner terminal 510 and come into contact with the inner terminal 510, and thus make an electrical connection. The connection terminal 522 protruding downward is formed at the center of the variable connecting portion 520. In particular, the connection terminal 522 may be a convex projection shape facing downward. The connection terminal 522 is located at the center of the variable connecting portion 520 and may be fixed to the support plate of the inner terminal 510. For example, the connection terminal 522 and the inner terminal 510 may be fixed by ultrasonic welding, and the connection terminal 522 may move away from the inner terminal 510 by internal gas pressure, thereby breaking an electrical connection.

The connection terminal 522 is fixed to the support plate 514 through a groove located in the center of the central body 512, and thus the connection terminal 522 and the inner terminal 510 are electrically connected. The connection terminal 522 and the support plate 514 may be welded by laser welding, ultrasonic welding, resistance welding, or an equivalent thereof.

At least one of the connection terminal 522 and the inner terminal 510 includes a magnet, and the connection terminal 522 and the inner terminal 510 may be connected/reconnected by magnetic force.

FIG. 16 is a cross-sectional view showing a state in which the variable connecting portion 520 according to another embodiment of the present disclosure has moved upward by internal gas pressure. As shown in FIG. 16, a connection magnet 524 may be positioned on the lower side of the connection terminal 522. The connection magnet 524 may provide only magnetic force, or may provide both magnetic force and electrical conductivity.

The wing member 525 extends from the connection terminal 522 to extend between the terminal cover 170 and the cylindrical can 110 and may be provided in various shapes that can separated into a plurality of members by internal gas pressure, with the members being subsequently reconnected by magnetic force. The wing member 525 is located on the outer periphery of the connection terminal 522, and the wing member 525 and the connection terminal 522 may be integrally formed.

The wing member 525 according to another embodiment of the present disclosure includes a first wing 526 and a second wing 527. The first wing 526 and the second wing 527 may be separated from each other by internal gas pressure of the secondary battery 1 and then reconnected by magnetic force.

As shown in FIGS. 15 and 16, the first wing 526 is connected to the connection terminal 522 and may being configured to provide a magnetic force. The first wing 526 is provided with a first magnet 526b. The first magnet 526b may be positioned at an end of the first wing 526 facing the second wing 527. The first wing 526 is located at the outer periphery of the connection terminal 522 and includes a first body 526a integrally formed with the connection terminal 522, and the first magnet 526b is fixed to the outer end of the first body 526a.

The first body 526a is located between the connection terminal 522 and the second wing 527 and may be formed in a donut shape. The inner side of the first body 526a may be connected to the connection terminal 522, and the outer side of the first body 526a may be connected to the second wing 527. The first magnet 526b may be provided on the outer edge of the first body 526a. The first magnet 526b may be a ring shape on the outer edge of the first body 526a. Alternatively, a plurality of first magnets 526b may be provided on the outer edge of the first body 526a at set intervals.

The second wing 527 is provided at a position facing the first wing 526, and may be modified into various shapes and provide a magnetic force. The second wing 527 is positioned at the outer periphery of the first wing 526. A first end of the second wing 527 is connected to the first wing 526, and a second end of the second wing 527 is in a shape that wraps around the edge of the terminal cover 170.

The second wing 527 is located on the outer periphery of the first wing 526 and includes a second body 527a in contact with the terminal cover 170 and a second magnet 527b fixed to a first end of the second body 527a. The second magnet 527b provided on the second wing 527 is positioned to face the first magnet 526b. The second magnet 527b may be provided at the end of the second wing 527 facing the first wing 526. The first magnet 526b and the second magnet 527b may provide magnetic forces and electrical conductivity.

The first magnet 526b and the second magnet 527b may be separated by internal gas pressure and then reconnected by the magnetic forces. The second body 527a is located on the outer periphery of the first body 526a and may be formed in a donut shape or a ring shape with a larger inner diameter than a diameter of the first body 526a.

The second magnet 527b may be a ring shape on the inner edge of the second body 527a. Alternatively, multiple second magnets 527b may be provided on the inner edge of the second body 527a at set intervals.

The first wing 526 and the second wing 527 each include an elastic material and, after the wing member 525 is separated, may be reconnected by magnetic force and elastic restoring force.

An upper notch 528 in the form a concave groove, may be further provided at the boundary where the first wing 526 and the second wing 527 are connected. A portion where the upper notch 528 is formed to be thinner than other portions of the wing member 525. Thus, when the wing member 525 is deformed by internal gas pressure, the deformation occurs around the portion where the upper notch 528 is formed.

A connection between the first wing 526 and the second wing 527 is made around the upper notch 528. The first wing 526 and the second wing 527 may be connected by a magnet. Additionally or alternatively, portions of the first wing 526 and the second wing 527 may be connected structurally connected.

Gas generated at the bottom of the cap assembly 500 moves upward through the connection hole 516a of the inner terminal 510 and moves the variable connecting portion 520 upward. As the variable connecting portion 520 moves upward due to the internal gas pressure, the connection terminal 522 and the support plate are separated. Therefore, the flow of current flowing from the inner terminal 510 through the variable connecting portion 520 is blocked.

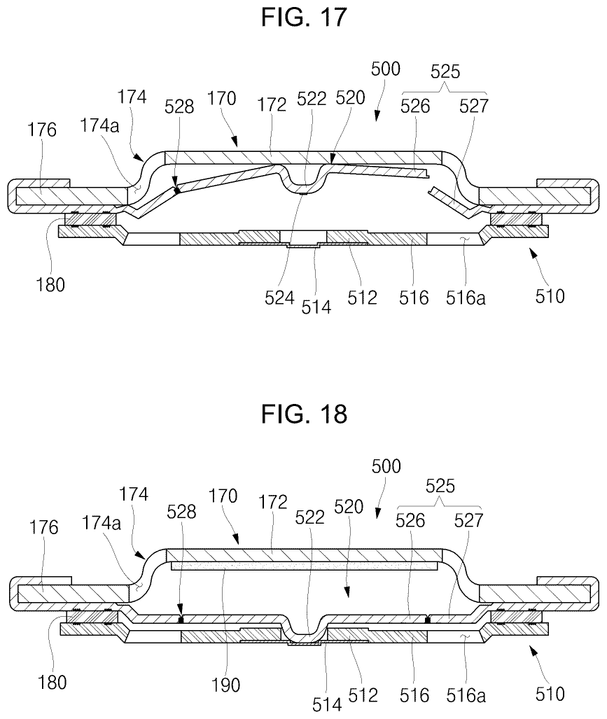

FIG. 17 is a cross-sectional view showing a state in which a variable connecting portion 520 according to another embodiment of the present disclosure is separated by internal gas pressure. As shown in FIG. 17, since the first wing 526 and the second wing 527 are separated from each other by internal gas pressure, the gas is discharged through between the first wing 526 and the second wing 527. The gas discharged to the outside of the wing member 525 is discharged to the outside of the terminal cover 170 through the terminal hole 174a of the terminal cover 170.

After the discharging of gas is completed, the first magnet 526b of the first wing 526 and the second magnet 527b of the second wing 527 are reconnected by magnetic force. In addition, the connection magnet 524 of the connection terminal 522 and the support plate 514 are reconnected again by magnetic force. Therefore the current from the inner terminal 510 can again be transmitted to the terminal cover 170 through the variable connection part 174.

FIG. 18 is a cross-sectional view showing a state in which a gas absorbent 190 is provided on the inside of a terminal cover 170 according to another embodiment of the present disclosure. As shown in FIG. 18, a gas absorbent 190 is provided on the lower surface of the terminal part 172. Thus, gas inside the cap assembly 500 may be absorbed without impeding the movement of the variable connecting portion 520.

The electrode assembly 120 according to the present disclosure will now be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO4(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

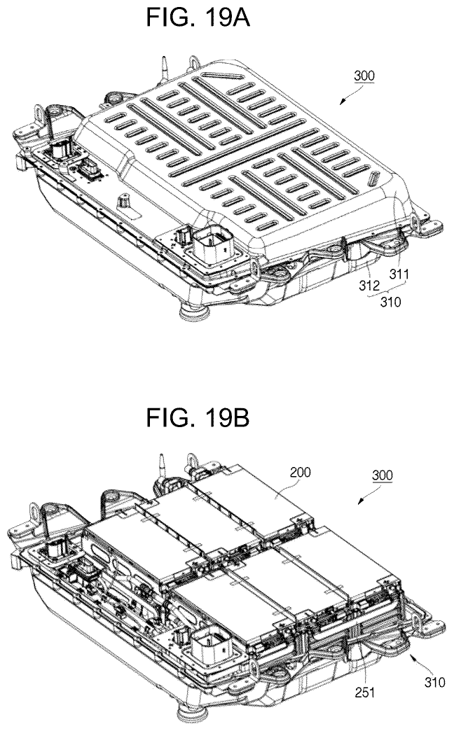

The batteries according to the above-described embodiments may be used to manufacture a battery pack. FIGS. 19A and 19B are perspective views showing a battery pack including the exemplary secondary battery according to the present disclosure. Referring to FIGS. 12A and 12B, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

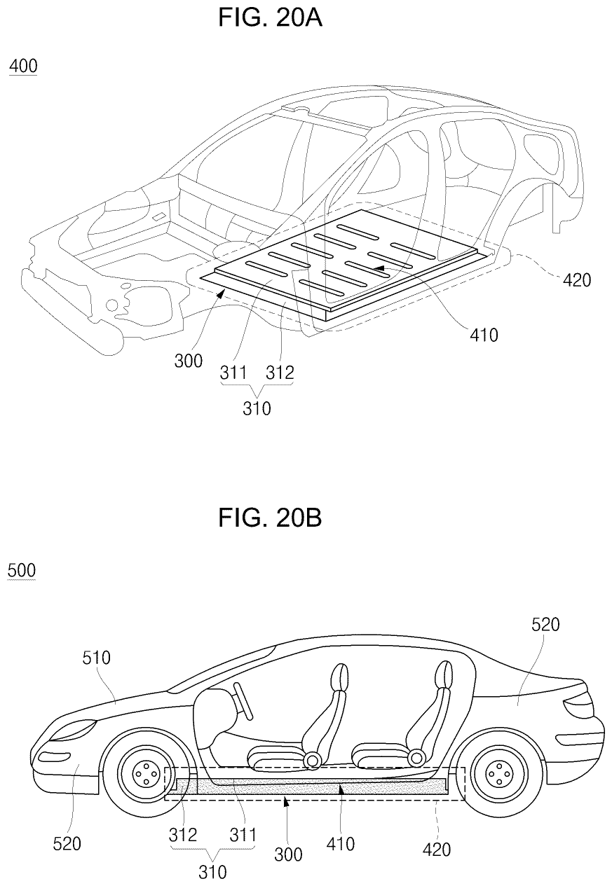

FIGS. 20A and 20B are, respectively, a perspective view and a side view showing vehicles 400 and 500 including the exemplary battery pack 300 according to the present disclosure.

In FIG. 20A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 20B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

Although a few embodiments of the present disclosure have been shown and described, it would be appreciated by those skilled in the art that various changes and modifications may be made in this embodiment without departing from the principles and spirit of the disclosure.

What is claimed is:

1. A secondary battery comprising:
a cylindrical can;
an electrode assembly positioned in the cylindrical can;
an inner terminal electrically connected to the electrode assembly and including a connection hole;
a variable connecting portion fixed to the cylindrical can and connected to the inner terminal, the variable connection portion including a body configured to disconnected from the inner terminal by gas pressure such that the variable connecting portion is electrically disconnected from the inner terminal, and the body being reconnectable to the inner terminal by magnetic force; and
a terminal cover electrically connected to the variable connecting portion and located outside of the cylindrical can.

2. The secondary battery as claimed in claim 1, wherein the variable connecting portion comprises:
a connecting body that is in contact with the inner terminal to make electrical connection; and
a wing member that extends from the connecting body to be provided between the terminal cover and the cylindrical can, and the wing member being configured to be separated into a plurality of members by the gas pressure and configured such the members are reconnected by magnetic force.

3. The secondary battery as claimed in claim 2, wherein the wing member comprises:
a first wing that is connected to the connecting body and provides a magnetic force; and
a second wing facing the first wing and connected to the first wing by the magnetic force.

4. The secondary battery as claimed in claim 3, wherein the wing member comprises:
a first magnet provided on the first wing; and
a second magnet provided on the second wing and facing the first magnet.

5. The secondary battery as claimed in claim 4, wherein the first magnet is provided at an end of the first wing facing the second wing.

6. The secondary battery as claimed in claim 4, wherein the second magnet is provided at an end of the second wing facing the first wing.

7. The secondary battery as claimed in claim 4, wherein the first magnet and the second magnet are configured to be separated by the gas pressure and then reconnected by magnetic forces of the first magnet and the second magnet.

8. The secondary battery as claimed in claim 3, wherein the first wing and the second wing each includes an elastic material, and the first wing and the second wing are configured such that, after the wing member is separated, the first wing and the second wing are reconnected by the magnetic force and elastic restoring force.

9. The secondary battery as claimed in claim 2, wherein the inner terminal comprises:
a movable body that is fixed to the connecting body and is configured to move together with the connecting body; and
a fixed body that is connected to the movable body, is positioned on a lower side of the wing member, and has a connecting hole, and
wherein the movable body and the fixed body are connected by magnetic force.

10. A secondary battery comprising:
a cylindrical can;
an electrode assembly positioned in the cylindrical can;
an inner terminal electrically connected to the electrode assembly and including a connection hole;
a variable connecting portion fixed to the cylindrical can and connected to the inner terminal, the variable connecting portion including a body configured to disconnected from the inner terminal by gas pressure such that the variable connecting portion is electrically disconnected from the inner terminal, and the body being reconnectable to the inner terminal by magnetic force;
a terminal cover electrically connected to the variable connecting portion and located outside of the cylindrical can; and
a gas absorbent positioned between the terminal cover and the variable connecting portion, the gas absorbent being configured to absorb gas.

11. The secondary battery as claimed in claim 10, further comprising an insulation gasket located between the terminal cover and the cylindrical can and blocking electrical connection between the terminal cover and the cylindrical can.

12. The secondary battery as claimed in claim 10, further comprising an insulation member located between the inner terminal and the variable connecting portion and blocking electrical connection between the inner terminal and the variable connecting portion.

13. The secondary battery as claimed in claim 10, wherein the variable connecting portion comprises:
a connection terminal protruding toward the inner terminal; and
a wing member that extends from the connecting body to be provided between the terminal cover and the cylindrical can, the wing member being configured to be separated into a plurality of members by gas pressure and configured such that the member are reconnected by magnetic force.

14. The secondary battery as claimed in claim 13, wherein the connection terminal and the inner terminal are fixed by ultrasonic welding, and electrical connection is blocked when the connection terminal moves away from the inner terminal by internal gas pressure.

15. The secondary battery as claimed in claim 13, wherein at least one of the connection terminal and the inner terminal includes a magnet, and the connection terminal and the inner terminal are connected by magnetic force from the magnet.

16. The secondary battery as claimed in claim 13, wherein the wing member comprises:
a first wing that is connected to the connection terminal and provides a magnetic force; and
a second wing facing the first wing and contacted to the first wing by the magnetic force.

17. The secondary battery as claimed in claim 16, wherein the wing member comprises:
a first magnet provided on the first wing; and
a second magnet provided on the second wing and facing the first magnet.

18. The secondary battery as claimed in claim 17, wherein the first magnet is provided at the end of the first wing facing the second wing, and the second magnet is provided at the end of the second wing facing the first wing.

19. The secondary battery as claimed in claim 17, wherein the first magnet and the second magnet provide electrical conductivity.

20. The secondary battery as claimed in claim 10, wherein the gas absorbent is composition that absorbs carbon dioxide, oxygen, ethylene, and water.
